(19) United States
(12) Patent Application Publication
(10) Pub. No.: US 2003/0120757 A1
(43) Pub. Date: Jun. 26, 2003

(54) Method and apparatus for providing a reminder service

(76) Inventors: Adrian Baldwin, Downend (GB); Richard Wills, Gifford (GB)

Correspondence Address: HEWLETT-PACKARD COMPANY, Intellectual Property Administration, P.O. Box 272400, Fort Collins, CO, 80527-2400, US

(21) Appl. No.: 10/298,775

(22) Filed: Nov. 18, 2002

(30) Foreign Application Priority Data
Nov. 20, 2001 (GB) 0127732.6

(51) Int. Cl. G06F 15/177

(52) U.S. Cl. 709/220

(57) ABSTRACT

A method of processing a request for a reminder to be sent to a user, comprising: (a) receiving, at a first node in a distributed network, a request for a reminder to be sent to the user on a specified occasion; and then (b) sending a derivative of the reminder to a second node in the said network. The derivative may be a replica or a fragment of the reminder. In the first case, the method preferably further comprises: (c) sending the reminder to the user from the first node on the specified occasion; and (d) sending a cancellation signal to the second node to instruct it not to send a reminder to the user. In the second case, the method preferably further comprises: (c) sending a fragment from the second node to the first node; (d) using the fragment to reconstruct the reminder; and (e) sending the reminder to the user on the specified occasion; or alternatively: (c) sending a fragment from the second node to the first node; (d) sending the fragment to the user on the specified occasion; and (e) using the fragment to reconstruct the reminder. Also provided by the invention is a node in a distributed network, the node being operable to receive a request for a reminder to be sent to a user on a specified occasion, and to send a derivative of the reminder to a second node in the said network.

This invention relates to a method and apparatus for providing a reminder service. It is particularly applicable, but in no way limited, for reminding a user of dates of relevance with regard to long term agreements (for example, legal agreements).

### BACKGROUND TO THE INVENTION

Many businesses rely on contracts and other legal agreements which operate over a long period of time (i.e. are long-term). The expression ‘long-term’ is used herein to mean a period in the order of years—typically several years to many tens (and possibly hundreds) of years. Long-term agreements often have an important deadline or due date that may be many years in the future. By their very nature, long-term contracts and agreements may well be more important than those that operate over a shorter timeframe, and hence it is extremely important that long-term deadlines are reliably managed and a reminder is issued at an appropriate time.

Examples of long-term agreements are intellectual property renewals. For example, a UK registered trade mark must be renewed ten years after the initial application for registration was made. Failure to observe such deadlines may have severe consequences, such as loss of legal rights. It is therefore essential that timely reminders be issued to the appropriate individuals so that action may be taken before the deadline.

As well as renewals, other long-term reminders may be required for other commercial purposes, such as submitting bids, or following up a debt. Contract management systems may also need reminders, such as to re-timestamp a contract after five years.

Short-term deadlines and reminders are often managed using a computer-based reminder service such as Microsoft (RTM) Outlook (RTM). Application software such as this may be run on a standalone computer or via a network using a server, and typically serves to remind users of deadlines and meetings over a short-term timeframe of days, weeks, months, or a few years. Whilst such software is generally very effective for short-term reminders, it is not well suited to the reliable management of long-term deadlines, for inter alia the following reasons:

Computer hardware, operating systems and software applications tend to have a relatively short working life. They are typically replaced or upgraded every two to four years. Local computing infrastructure and networking may also be changed. As a consequence of these upgrade processes, and since the time until the reminder is required may well be longer than the lifetime of the computer system, long-term reminders stored locally may be lost or overlooked.

Reminders stored on a local computer or a local server are also not completely reliable since the computers themselves are susceptible to hard disk corruption, fire, theft, and acts by third parties such as arson or terrorist attacks. Whilst backups may be made, e.g. onto a cassette, there is still no guarantee that important reminders will be reliably maintained. Accordingly, there is clearly a need for a robust, resilient reminder service which remains resilient over a long timescale.

Remote third party service providers may be instructed to manage reminders (e.g. intellectual property renewals) on behalf of a user/subscriber, and to issue an appropriate reminder when the time comes. However, these may also not be wholly reliable, since the service provider may well be exposed to the same risks and problems as discussed above. There is also no guarantee to the user that a given reminder service will even still be in business when the reminder is due.

The information relating to the reminder may be of a highly confidential and commercially sensitive nature. Therefore it is highly desirable that confidentiality can be guaranteed by any third party reminder service providers. It will be appreciated that, whilst encryption techniques may be used, decryption keys may expire or simply be lost.

Additionally, if a third party reminder service provider is used, then there is a further potential problem in that, in the organisation requiring the reminder, the appointed responsible person may leave the organisation, or the responsibility may pass to another employee. Furthermore, the organisation as a whole may move premises. It is essential that these factors be taken into account to ensure that the reminder message is successfully passed on to the intended personnel.

it is a general object of the present invention to provide a reminder service which overcomes or at least mitigates at least some of the problems and shortcomings identified above.

### SUMMARY OF THE INVENTION

According to a first aspect of the invention there is provided a method of processing a request for a reminder to be sent to a user, comprising: (a) receiving, at a first node in a distributed network, a request for a reminder to be sent to the user on a specified occasion; and then (b) sending a derivative of the reminder to a second node in the said network.

The term ‘network’ used herein refers to a digital communications network. It is envisaged that preferably this would at least partially be the Internet, or another wide area network, since a broad geographical spread of nodes will mean that the system is better safeguarded against local disasters such as war, earthquakes or other disasters.

The term ‘node’ used herein refers to a data processing means on the network. Accordingly, a node may, for example, be a webserver or some other data storage and/or processing device. In implementing the present invention, it is envisaged that the nodes will operate substantially independently of one another. Whilst they may be run by different organisations, the possibility that they may be run by the same organisation is by no means excluded.

The term ‘user’ referred to herein relates to the entity requiring the reminder on some predetermined occasion in the future. A user may be an individual or an organisation. Some users may subscribe to use a reminder service run by a third party in accordance with the present invention, whilst others may implement their own reminder service, also in accordance with the present invention.

The reminder message may be encrypted and transmitted over the network, for example as an encrypted email, with the user having the requisite key to decrypt the reminder to render it comprehensible.

Preferably, the derivative is a replica of the said reminder. This advantageously provides a robust, resilient system for processing reminder messages, since if one node is unable to process the reminder then another node in the network, having a replica of the reminder, will be able to process it instead.

Preferably, the method further comprises: (c) sending the reminder to the user from the first node on the specified occasion; and (d) sending a cancellation signal to the second node to instruct it not to send a reminder to the user. Successfully sending a cancellation signal to the second node will advantageously result in the user not being inconvenienced with more than one identical reminder. It will be appreciated that if, for whatever reason, the cancellation signal is not received by the second node, then the user may be sent more than one reminder message. However, this is, of course, preferable to receiving no reminder at all.

Preferably the method further comprises the second node sending the reminder to the user after a predetermined interval of time after the said specified occasion, if it has not received the said cancellation signal sent by the first node. By incorporating this predetermined time delay before sending the reminder to the user, the second node is able to receive the cancellation signal from the first node if such a cancellation signal is indeed forthcoming.

The method preferably further comprises a node receiving a cancellation signal and forwarding the cancellation signal to a node to which it has previously sent a replica of the reminder. This enables the cancellation signals to be propagated throughout the network in an controlled, rigorous manner.

Preferably, the reminder is sent to the user by e-mail. This advantageously provides a straightforward automated system by which the reminder may be sent to the user. If the reminder cannot successfully be sent to the said user, then the method further comprises sending the reminder to a specified reserve contact.

If the reminder cannot successfully be sent by e-mail, the method further comprises reminding the user by a method selected from a group comprising: telephone, fax and post; using specified coordinates associated with the user.

According to an alternative implementation of the first aspect of the invention, the derivative may be a fragment of the said reminder.

Particularly preferably, the fragment is one of a plurality of fragments, the fragments being such that a predetermined number of fragments are required to be received at the first node in order to reconstruct the reminder. This has the advantage that the system is secure, in that a single fragment is insufficient to enable the reminder to be reconstructed. The reminder system thereby preserves the confidentiality of the messages entrusted in it, since no individual node is able to reconstruct the entire of the reminder.

The method preferably further comprises: (c) sending a fragment from the second node to the first node; (d) using the fragment to reconstruct the reminder; and (e) sending the reminder to the user on the specified occasion. Alternatively, the method further comprises: (c) sending a fragment from the second node to the first node; (d) sending the fragment to the user on the specified occasion; and (e) using the fragment to reconstruct the reminder. The fragments are unintelligible when separated from one another, until they are brought together and the reminder reconstructed.

Preferably step (c) of the method comprises sending the fragment from the second node to a substitute first node if the fragment cannot be sent to the intended first node. This advantageously means that the reminder is not lost if the intended first node is inaccessible for any reason.

Preferably, the first node is external from the user's organisation. This way, the reminder may be reconstructed and then sent back to the user in a readily-intelligible form. As an alternative preference, the first node may be within the user's organisation. In this latter case, the reminder is thereby reconstructed only within the user's organisation, and accordingly no external third party can ever avail itself of the full details of the reminder.

In accordance with a second aspect of the invention there is provided a method of sending a reminder to a user of a reminder service, the reminder being replicated on a plurality of nodes in a distributed network, comprising a node sending the reminder to the user on a specified occasion and also sending a cancellation signal to another node in the network to instruct it not to send the reminder to the user. It will be appreciated that this method may be used to issue a reminder to a user without the user first having had to explicitly request it. Preferably, for the reason already given above, this method further comprises a node sending the reminder to the user at a predetermined interval of time after the said specified occasion, if it has not received a cancellation signal.

The method preferably further comprises a node receiving a cancellation signal and forwarding the cancellation signal to a node to which it has previously sent a replica of the request.

As before, the reminder may be sent to the user by e-mail, and a reminder may be sent to a specified reserve contact if it cannot successfully be sent to the said user. Alternatively, if the reminder cannot successfully be sent by e-mail, the user may be reminded by a method selected from a group comprising: telephone, fax and post; using specified co-ordinates associated with the user.

In accordance with a third aspect of the invention there is provided a method of sending a reminder to a user of a reminder service, the reminder being fragmented and the fragments being held on nodes in a distributed network, comprising: recombining fragments to reconstruct the reminder and sending the reminder to the user on a specified occasion.

According to a fourth aspect of the invention there is provided a method of sending a reminder to a user of a reminder service, the reminder being fragmented and the fragments being held on nodes in a distributed network, comprising: sending fragments to the user on a specified occasion and recombining the fragments to reconstruct the reminder.

The third and fourth aspects of the invention advantageously enable a reminder to be issued to a user, by way of the recombination of fragments, without the user first having had to explicitly request it.

According to an apparatus aspect of the invention there is provided a node in a distributed network, the node being operable to receive a request for a reminder to be sent to a user on a specified occasion, and to send a derivative of the reminder to a second node in the said network.

In one case, preferably the derivative is a replica of the said reminder. In this case, the node is preferably further operable to send the reminder to the user from the first node on the specified occasion, and to send a cancellation signal to the second node to instruct it not to send a reminder to the user. The node is also preferably further operable to send the reminder to the user at a predetermined interval of time after the said specified occasion, if it has not received a cancellation signal. Preferably the node is also further operable to receive a cancellation signal and to forward the cancellation signal to a node to which it has previously sent a replica of the request.

Alternatively, preferably the derivative is a fragment of the said reminder. In this case, preferably the node is further operable to recombine the fragment with other fragments to reconstruct the reminder.

### BRIEF DESCRIPTION OF THE DRAWINGS

Embodiments of the invention will now be described, by way of example, and with reference to the drawings in which:

FIG. 1 illustrates a distributed network having nodes in accordance with the present invention, showing the replication and propagation of a reminder message across the nodes;

FIG. 2 illustrates the sending of a reminder to a user and cancellation signals to other nodes on a flawless network;

FIG. 3 illustrates the sending of a reminder to a user and cancellation signals to other nodes on a flawed network;

FIG. 4 illustrates the fragmentation of a reminder and the distribution of the fragments to different nodes on a distributed network;

FIG. 5 illustrates the reconstruction of a reminder and its delivery to a user; and

FIG. 6 illustrates an alternative network incorporating a reminder service manager.

### DETAILED DESCRIPTION OF PREFERRED EMBODIMENTS

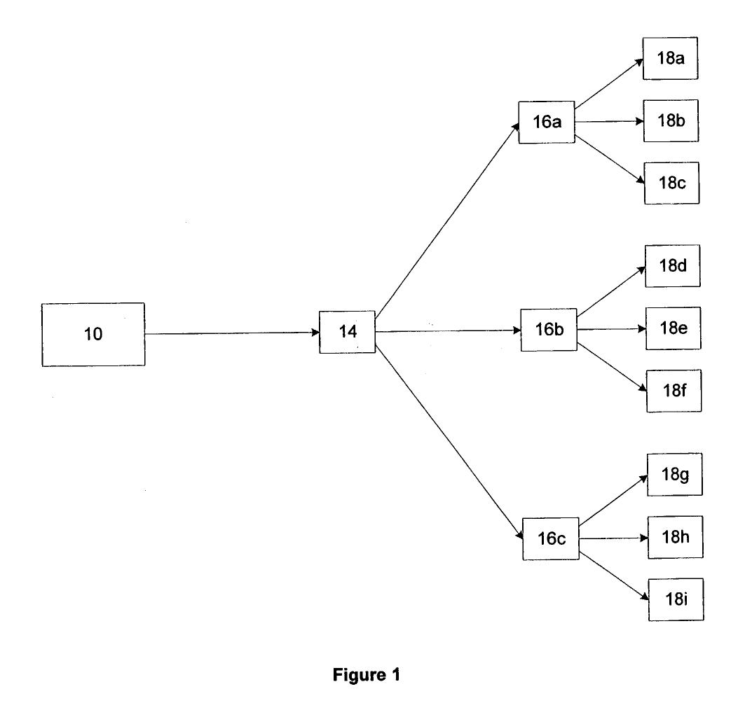

FIG. 1 illustrates an example of a digital communications network configured to provide a reminder service in accordance with a first aspect of the present invention. The user 10 (or client) of the reminder service sends a request for a reminder to the reminder service provider 14. The request specifies the date when the reminder is due, and may also specify details of the subject of the reminder (e.g. a contract renewal deadline).

The identity of the person to whom the reminder should be returned is also specified, together with that person's e-mail address, and optionally telephone and fax numbers and their postal address. One or more reserve contact(s), should the intended recipient be unable to be contacted for whatever reason, may also be specified.

Instead of specifying an individual, the reminder may be configured to be sent to a person holding a specified position within the client organisation. At the time of providing the reminder, the reminder service provider interrogates a database maintained by the client organisation, in which database the actual identities (and corresponding contact details) are correlated with the appropriate positions within the company. That is to say, if the reminder service provider has been instructed to send the reminder to the contracts renewals manager, for example, then this database will be interrogated to determine the identity of the contracts renewals manager at that time, and it will be to him that the reminder will be sent. This database, which may be held within the client organisation or by a reminder service provider, provides the great advantage that if a person leaves that role within the organisation, the service provider is still able to determine the identity of the appropriate individual to whom the reminder is to be sent.

Having provided the reminder service provider 14 with the details of the reminder, the reminder service provider 14 replicates the reminder, retains a copy, and sends replicas to other reminder service providers 16a, 16b, 16c (which may be abbreviated herein to 16a-c). These reminder service providers are preferably widely distributed geographically, and may well be run by different companies. As shown in FIG. 1, these reminder service providers 16a, 16b, 16c themselves replicate the reminder and send replicas to yet more reminder service providers 18a, 18b, 18c, 18d, 18e, 18f, 18g, 18h, 18i (abbreviated herein to 18a-i). It will be appreciated that such a hierarchical arrangement of nodes in the network may readily be extended to incorporate additional levels of hierarchy, with alternative arrangements of dependency between the nodes.

Each node is, in principle, capable of acting upon the replicated reminder that it has been sent. That is to say, unless it is subsequently unable to function, each node is operable to send the reminder back to the user.

The replicas of the reminder sent across the network are substantially identical, at least insofar as the details of the reminder (time/date, description, contact identity etc) are concerned, and may be encrypted. However, with each successive level in the hierarchy, a relatively small time delay is preferably added to the time at which the reminder will be sent back to the user. For example, node 14 may be configured to send the reminder back to the user without any time delay, nodes 16a, 16b and 16c may each be configured to apply a time delay of 15 minutes, and nodes 18a-i may each be set to apply a delay of 30 minutes.

If the user's contact details (identity, e-mail address, postal address, telephone and fax numbers, etc.) change, then the updated details may also be sent from the user 10 to the first node 14 and then propagated to the other nodes in the same manner as the replicated reminder. Each node is therefore kept informed of the up-to-date details of where the reminder is to be sent. Update information should be signed to ensure its validity.

Each node is responsive to a reminder-specific cancellation signal, receipt of which will cause the node not to send the reminder to which the cancellation signal relates. The cancellation signals may be signed to ensure their validity.

On receiving a cancellation signal, each node is also capable of forwarding the cancellation signal to other nodes to which it is aware. These other nodes are those to which it has previously sent a reminder, and may also be nodes from which it has previously received a reminder.

The propagation of the cancellation signals co-operates with the time delays applied to the reminder message in each successive level of the hierarchy. That is to say, each time delay gives the respective node the opportunity to receive a cancellation signal before sending the reminder back to the user.

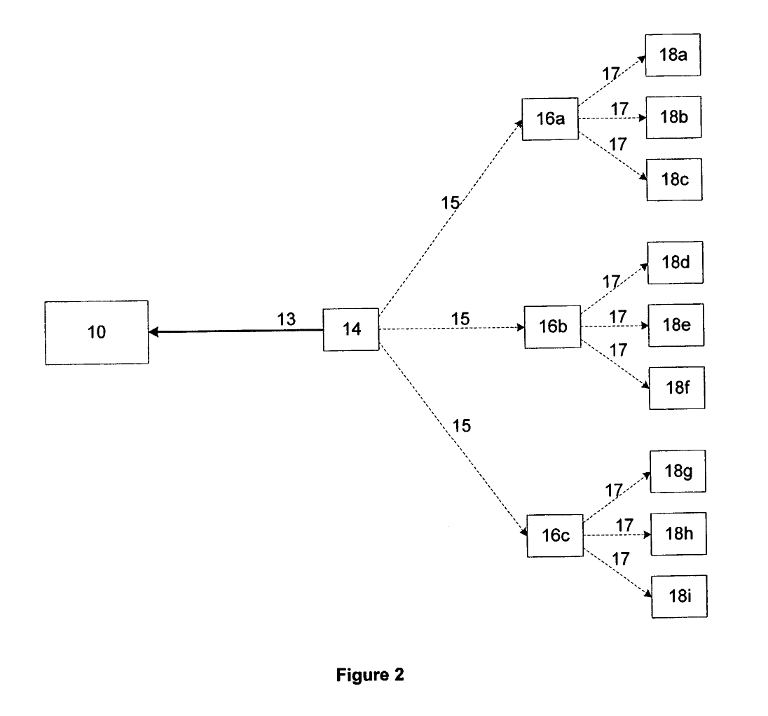

With the reminder having been replicated across the network, the months or years pass until the time comes for the reminder to be sent back to the user. The integrity of the network and the operability of the nodes may have changed during this time. In the example illustrated in FIG. 2, the network has stayed fully intact with all the nodes remaining operational. Accordingly, at the time when the reminder is due, the first node 14 sends the reminder message 13 by e-mail (which may be encrypted) back to the user 10. At substantially the same time as sending the reminder message 13, the node 14 also sends cancellation signals 15 to the nodes 16a-c to which it had previously sent replicas of the reminder. If the system operates according to plan, these cancellation signals are received by the nodes 16a-c before their time delay (e.g. 15 minutes) has expired, and consequently these nodes do not then send the reminder to the user 10. Nodes 16a-c also forward the cancellation signal to the other nodes 18a-i to which nodes 16a-c had previously sent replicas of the reminder. Again, if all goes according to plan, nodes 18a-i receive the cancellation signals before the expiry of their time delay (30 minutes in the above-mentioned example), and so these nodes too do not send the reminder back to the user. As a result of the propagation of the cancellation signals, the user 10 only receives one reminder 13, which is the desired outcome.

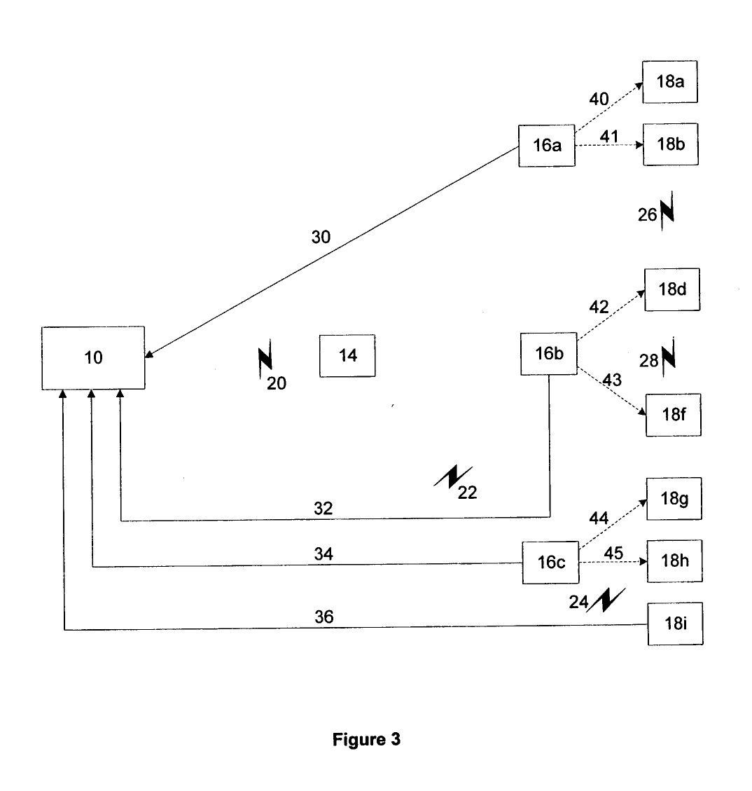

The above example involved what was essentially a flawless network that remained fully operational despite the passage of time. In FIG. 3, however, a flawed network is considered. As before, each of the nodes 14, 16a-c and 18a-i had been issued with the reminder or a replica thereof, and time has elapsed such that the reminder is now due to be sent back to the user 10. However, certain aspects of the network are no longer operational—perhaps due to having been removed, shut down or damaged in some way. In other cases the node may no longer exist due to a variety of reasons. As shown in FIG. 3, there are no longer network connections between the user 10 and node 14 (the absence of a connection being indicated by the symbol 20), between node 14 and node 16c (as indicated by the symbol 22), and between node 16c and node 18i (as indicated by the symbol 24). The nodes 18c and 18e are no longer operational (as indicated by the symbols 26 and 28 respectively). However, despite these many faults, the system as a whole remains capable of providing a satisfactory reminder service to the user 10, in the following manner:

At the specified time when the reminder is required, node 14 (to which the replicated reminder was first sent) attempts to send the reminder back to the user 10. However, since there is no operational connection between this node 14 and the user 10, node 14 cannot send the reminder to the user. As a consequence, node 14 does not send a cancellation signal to nodes 16a-c. Therefore, after the predetermined time delay (say 15 minutes), in the absence of receiving a cancellation signal nodes 16a, 16b and 16c each send their replicas of the reminder (30, 32 and 34) back to the user 10. Each of these nodes 16a-c also forwards cancellation signals to those nodes to which they had previously sent replicas. That is to say, node 16a sends cancellation signals (40, 41) to nodes 18a and 18b. (Node 18c is no longer operational, and so no cancellation signal can be sent to it.) Similarly, node 16b sends cancellation signals (42, 43) to nodes 18d and 18f (node 18e is also unavailable), and node 16c sends cancellation signals (44, 45) to nodes 18g and 18h. Since node 16c cannot communicate with node 18i (due to the fault 24), no cancellation signal is transmitted to node 18i. As a consequence of not having received a cancellation signal, node 18i also sends a reminder 36 to the user 10.

Although, as in the example described above, a flawed network may result in more than one reminder being sent to the user, this is greatly preferable over the user receiving no reminder at all.

E-mail transmission of reminder messages to the user is preferred, since these may be generated and sent automatically. If a node is unable to successfully send an e-mail reminder to the intended recipient (e.g. if the e-mail bounces, or no delivery receipt is received) then the e-mail address of the reserve contact(s) may be used. If this is also unsuccessful, a fax or a posted reminder message may be sent (using the appropriate contact details held with the reminder) or a representative of the reminder service provider may telephone the user to pass on the reminder.

One shortcoming of the above embodiment of the invention is that each node may be able to see the details of the reminder, even if it is held in an encrypted form. It will be appreciated that it is unwise to rely on the user to have the appropriate key to decrypt the reminder, since there is no guarantee that the user will still have the key in the future. This shortcoming is addressed by a second embodiment of the invention:

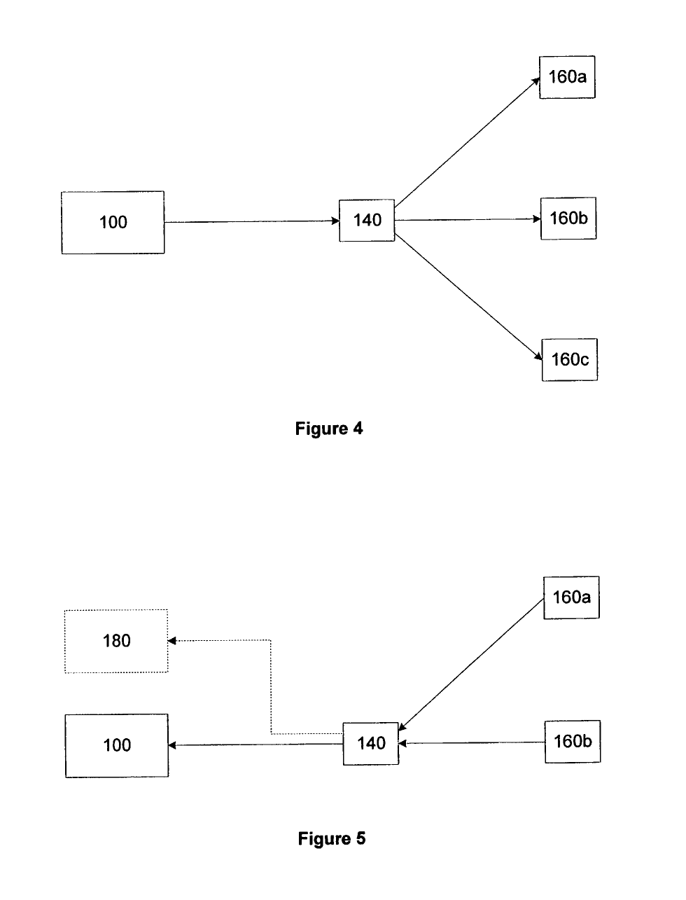

A second embodiment of the invention will now be described with reference to FIGS. 4 and 5. This embodiment, which provides security and ensures the confidentiality of the reminder messages, may be used in conjunction or combination with the embodiment of the invention providing a robust and resilient reminder service as described above.

In FIG. 4, a request for a reminder is first sent from the user 100 via a digital communications network to a first node 140. The first node 140 may be within the user's organisation, or may be an external trusted reminder service manager.

The request sent to the first node 140 requests that a reminder message be issued to the user on a future specified occasion. The user's contact details are also provided to this first node 140. (If, at a future point, these contact details change, then the revised details are also provided to this node 140.) Reserve contact details may also be provided in case the nominated contact is unobtainable when the time comes to issue the reminder.

On receipt of the request for a reminder, the first node 140 splits the reminder into fragments using a key sharing algorithm and sends each fragment to other nodes 160a, 160b, 160c, each of which provides an independent reminder service. Each fragment sent by the second node is accompanied by the identity or address of the first node, together with the date on which the reminder is to be reconstructed. In the interest of security, the reminder is not retained by the first node 140.

The fragments of the reminder are such that each fragment only contains part of the data that constitutes the reminder. Furthermore, each fragment is cryptographically strong such that, without colluding, individual nodes can gain no knowledge of the details of the reminder message.

With reference now to FIG. 5, on the specified date for reconstruction of the reminder message, the nodes holding fragments send their respective fragments back to the first node 140 for reconstruction of the reminder message. The fragments are such that the first node 140 is able to reconstruct the entirety of the message on receipt of a certain number of the fragments. The number of fragments required for this is particularly preferably less than the total number of fragments that were generated. In the example shown in the Figures, although three fragments were generated, any two are sufficient for the reminder to be completely reconstructed. This provides a degree of resilience to the reminder service, since if a node is unable to deliver the fragment back to the first node 140, there remains a strong likelihood that sufficient fragments will nevertheless be returned to enable the reminder to be reconstructed. Accordingly, FIG. 5 shows only two nodes (160a and 160b) sending fragments back to the first node 140, but in this example this is sufficient. The user may specify the degree of resilience required by the system, which will determine the number of fragments that are required for reconstruction of the reminder.

Obfuscation techniques may be used to make it harder for the nodes to collude and identify several fragments from the same reminder message.

Once the reminder has been reconstructed by the first node 140, it is sent back to the user 100, preferably by e-mail in the interest of automation. A posted or faxed reminder may be sent instead of an e-mail if this is unsuccessful, or a telephone call may be used. If the nominated contact cannot be reached then the reminder service manager attempts to contact the reserve contact(s) instead.

In case the first node is inoperable to receive the fragments to reconstruct the reminder, a substitute first node 180 may be provided that is operable to reconstruct the message. A plurality of substitute first nodes may be provided to give additional resilience to the system. The address of each substitute first node is given to the nodes that hold the fragments, so that they are able to deliver the fragments to a node that is able to reconstruct the reminder. Accordingly, it is envisaged that each trusted reminder service manager will have negotiated agreements for backup services with other service providers or sites.

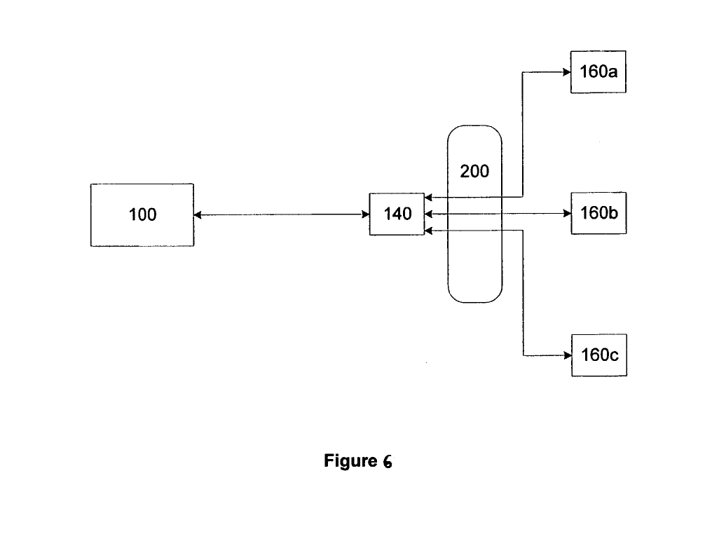

If a third party trusted reminder service provider is used to provide the first node, then it follows that the user must trust them to maintain the confidentiality of the reminder before it is fragmented, and after the reminder is reconstructed. However, as mentioned above, the first node 140 may be within the user's organisation, which advantageously provides the most secure solution. As shown in FIG. 6, in this case a reminder service manager 200 is used essentially as a routing agent for the fragments of the reminder. The reminder is fragmented and later reconstructed on the first node 140 within the user's organisation. The reminder service manager 200 is used to direct the fragments out to the storage nodes 160a-c, and to maintain the address of the first node to which the fragments are later to be sent for reconstruction. If the address of the first node changes, then the user 100 is required to notify the reminder service provider 200 of this change. At the time when the reminder is to be reconstructed, the storage nodes 160a-c send their fragments to the first node 140, either via the reminder service manager 200 or directly to the first node 140, using an address as specified by the reminder service manager 200. As a further security provision, the address may be required to comply with user-specified restrictions, such as, for example, being within a specified domain (for example, hp.com).

1. A method of processing a request for a reminder to be sent to a user, comprising:
(a) receiving, at a first node in a distributed network, a request for a reminder to be sent to the user on a specified occasion; and then
(b) sending a derivative of the reminder to a second node in the said network.

2. A method as claimed in claim 1 wherein the derivative is a replica of the said reminder.

3. A method as claimed in claim 2 further comprising:
(c) sending the reminder to the user from the first node on the specified occasion; and
(d) sending a cancellation signal to the second node to instruct it not to send a reminder to the user.

4. A method as claimed in claim 3 further comprising the second node sending the reminder to the user after a predetermined interval of time after the said specified occasion, if it has not received the said cancellation signal sent by the first node.

5. A method as claimed in claim 3 further comprising a node receiving a cancellation signal and forwarding the cancellation signal to a node to which it has previously sent a replica of the reminder.

6. A method as claimed in claim 3, wherein the reminder is sent to the user by e-mail.

7. A method as claimed in claim 6 further comprising sending the reminder to a specified reserve contact if the reminder cannot successfully be sent to the said user.

8. A method as claimed in claim 6, further comprising reminding the user by a method selected from a group comprising: telephone, fax and post; using specified co-ordinates associated with the user, if the reminder cannot successfully be sent by e-mail.

9. A method as claimed in claim 1 wherein the derivative is a fragment of the said reminder.

10. A method as claimed in claim 10, wherein the fragment is one of a plurality of fragments, the fragments being such that a predetermined number of fragments are required to be received at the first node in order to reconstruct the reminder.

11. A method as claimed in claim 9 further comprising:
(c) sending a fragment from the second node to the first node;
(d) using the fragment to reconstruct the reminder; and
(e) sending the reminder to the user on the specified occasion.

12. A method as claimed in claim 10, wherein step (c) of the method comprises sending the fragment from the second node to a substitute first node if the fragment cannot be sent to the intended first node.

13. A method as claimed in claim 9 further comprising:
(c) sending a fragment from the second node to the first node;
(d) sending the fragment to the user on the specified occasion; and
(e) using the fragment to reconstruct the reminder.

14. A method as claimed in claim 13, wherein step (c) of the method comprises sending the fragment from the second node to a substitute first node if the fragment cannot be sent to the intended first node.

15. A method as claimed in claim 1, wherein the first node is external from the user's organisation.

16. A method as claimed in claim 1, wherein the first node is within the user's organisation.

17. A method of sending a reminder to a user of a reminder service, the reminder being replicated on a plurality of nodes in a distributed network, comprising a node sending the reminder to the user on a specified occasion and also sending a cancellation signal to another node in the network to instruct it not to send the reminder to the user.

18. A method as claimed in claim 17 further comprising a node sending the reminder to the user at a predetermined interval of time after the said specified occasion, if it has not received a cancellation signal.

19. A method as claimed in claim 17 further comprising a node receiving a cancellation signal and forwarding the cancellation signal to a node to which it has previously sent a replica of the reminder.

20. A method as claimed in claim 17, wherein the reminder is sent to the user by e-mail.

21. A method as claimed in claim 20 further comprising sending the reminder to a specified reserve contact if the reminder cannot successfully be sent to the said user.

22. A method as claimed in claim 20 further comprising reminding the user by a method selected from a group comprising: telephone, fax and post; using specified co-ordinates associated with the user, if the reminder cannot successfully be sent by e-mail.

23. A method of sending a reminder to a user of a reminder service, the reminder being fragmented and the fragments being held on nodes in a distributed network, comprising: recombining fragments to reconstruct the reminder and sending the reminder to the user on a specified occasion.

24. A method of sending a reminder to a user of a reminder service, the reminder being fragmented and the fragments being held on nodes in a distributed network, comprising: sending fragments to the user on a specified occasion and recombining the fragments to reconstruct the reminder.

25. A node in a distributed network, the node being operable to receive a request for a reminder to be sent to a user on a specified occasion, and to send a derivative of the reminder to a second node in the said network.

26. A node as claimed in claim 25, wherein the derivative is a replica of the said reminder.

27. A node as claimed in claim 26 further operable to send the reminder to the user from the first node on the specified occasion, and to send a cancellation signal to the second node to instruct it not to send a reminder to the user.

28. A node as claimed in claim 26 further operable to send the reminder to the user at a predetermined interval of time after the said specified occasion, if it has not received a cancellation signal.

29. A node as claimed in claim 26 further operable to receive a cancellation signal and to forward the cancellation signal to a node to which it has previously sent a replica of the request.

30. A node as claimed in claim 25, wherein the derivative is a fragment of the said reminder.

31. A node as claimed in claim 30 further operable to recombine the fragment with other fragments to reconstruct the reminder.
